(19) United States
(12) Patent Application Publication
(10) Pub. No.: US 2011/0222642 A1
(43) Pub. Date: Sep. 15, 2011

(54) SFR NUCLEAR REACTOR OF THE INTEGRATED TYPE WITH IMPROVED COMPACTNESS AND CONVECTION

(76) Inventor: Guy-Marie Gautier, Pertuis (FR)

(21) Appl. No.: 13/129,485

(22) PCT Filed: Oct. 12, 2009
(86) PCT No.: PCT/EP2009/063274

§ 371 Date: May 16, 2011

(30) Foreign Application Priority Data
Nov. 19, 2008 (FR) 08 57862

(51) Int. Cl. G21C 1/02; G21C 15/247; G21C 1/32

(52) U.S. Cl. 376/395

(57) ABSTRACT

The invention relates to a novel architecture for a nuclear reactor of the integrated type.

The invention comprises:

realising the hot area and cold area separation device for the primary sodium flow in the form of two walls with cuts,

providing two pumping groups hydraulically in series, one for the flow of sodium from the hot area to the cold area through the intermediate exchangers and the other in the cold area;

providing outlet windows of the intermediate exchangers below the lower wall;

providing outlet windows of the removal exchangers of the decay heat above the cold area, wherein all of clearances between the walls with cuts and the heat removal exchangers and the height between the two walls with cuts are previously determined so as to, during normal operation, take up differential movements between the walls, exchangers and vessel and to make it possible to establish during normal operation a thermal stratification of the primary sodium in the space defined between the horizontal portions of the two walls and so as to reduce, in case of an unexpected stop of a single pumping group, the mechanical stress applied to the walls and due to the portion of the primary sodium flow passing between said clearances.

### TECHNICAL FIELD

The invention relates to a sodium cooled nuclear reactor designated SFR (Sodium Fast Reactor), which forms part of the family of reactors known as fourth generation.

More specifically, the invention relates to a sodium cooled nuclear reactor, of the integrated type, in other words in which the primary circuit is fully contained in a vessel also containing the primary pumps and heat exchangers.

The invention proposes an innovative architecture of the primary circuit contained in the vessel of the reactor making it possible to improve its compactness, to facilitate the design of certain parts and to improve the natural convection of sodium in the vessel.

### STATE OF THE PRIOR ART

Sodium cooled fast reactors (SFR) normally comprise a vessel in which is placed the core with, above the core, a core control plug. The heat extraction takes place by circulating sodium, known as primary sodium, by means of a pumping system placed inside the vessel. This heat is transferred to an intermediate circuit, via one or more intermediate exchanger(s) (El), before being used to produce steam in a steam generator (GV). This steam is then sent into a turbine to transform it into mechanical energy, in its turn transformed into electrical energy.

The intermediate circuit comprises sodium as coolant and has the purpose of isolating (or in other words containing) the primary sodium that is in the vessel, in relation to the steam generator, on account of the violent reactions capable of occurring between sodium and the water-steam contained in the steam generator in the event of any rupture of a tube of said generator. Thus, the architecture puts an emphasis on two sodium circuits: one known as primary, charged with transferring the heat between the core and one or more intermediate heat exchanger(s), the other known as secondary charged with transferring the heat from the intermediate exchanger(s) to the steam generator.

All sodium cooled fast reactors (SFR) have common technical characteristics. The vessel is closed off on the top by a covering slab in order that the primary sodium is not in contact with the external air. All of the components (exchangers, pumps, pipes, etc.) pass through this slab vertically to be able to be dismantled by lifting them vertically with a lifting device. The dimensions of the through holes in this slab depend on the size and the number of components. The larger the dimensions of the holes and the greater their number are, the larger the diameter of the vessel will be.

The different technical solutions retained to date may be classified into two major families of reactors: loop type reactors and integrated type reactors.

SFR loop type reactors are characterised by the fact that the intermediate exchanger and the devices for pumping the primary sodium are situated outside of the vessel.

An example of reactor according to this architecture is that planned under the name JSFR, as represented schematically in FIG. 1. In the SFR loop reactor of FIG. 1, the sodium passes through the core 1 to take away the calories produced. At the outlet of the core 1, it emerges into an area 2 of the vessel 3 of the reactor: this area 2 is commonly known as hot collector. By loop, a pipe 4 emerges into the hot collector to suck up the primary sodium and convey this sodium to the intermediate exchanger (not represented in the figure), where it will give up the heat to the secondary sodium. At the outlet of the intermediate exchanger, the primary sodium is taken up by a pump and is sent directly to the inlet of the core 1, in other words below the core 1, by means of the pipe 5 emerging below the core 1.

The main advantage of a SFR loop type reactor is, for a given power, to obtain a vessel of smaller diameter than that of a SFR reactor of integrated type, because the vessel contains fewer components. The vessel is thus easier to manufacture and thus less expensive. On the other hand, a SFR loop type reactor has the major drawback of making the primary sodium come out of the vessel, which complicates the primary circuit architecture and poses important safety problems. Thus, the advantages linked to the reduced size and the easier manufacture of the vessel are cancelled by the extra costs induced by the addition of devices linked to the design of the loops and special means to manage any leaks of primary sodium.

SFR reactors of integrated type are characterised by the fact that the intermediate exchangers and the pumping means of the primary sodium are fully situated in the vessel, which makes it possible to avoid having the primary circuit go outside the vessel and thus constitutes an important advantage in terms of safety compared to an SFR loop type reactor.

A reactor with such an architecture has already been retained in the “SuperPhenix” reactor in France, or in that planned under the designation EFR, as described in the manual “Les Techniques de I'Ingénieur B 3 171” and as represented schematically in FIG. 2. In the SFR reactor of integrated type in FIG. 2, during normal operation of the reactor, the primary sodium passes through the core 11 to carry off the calories produced. At the outlet of the core 11, it arrives in an area 12 of the vessel 13 of the reactor shut off by the covering slab 24: this area 12 is commonly known as hot collector. Said hot collector is separated from another area 14 known as cold collector by a wall 15 of cylindrical-conical shape known as a redan. The shape of the redan 15 is known as cylindrical-conical because it is constituted of a lower portion 15a that surrounds the core 11 and which has a general shape of cone frustum and of an upper portion 15b which is a cylindrical portion. Each intermediate exchanger 16 is composed of a bundle of tubes. An example of embodiment of an intermediate exchanger 16 used in SFR reactors of integrated type is shown in FIG. 2A. The intermediate exchanger 16 represented comprises a central conduit 160 for supplying the secondary sodium connected to an input pipe 28 and emerging into a hemispheric cap 161 known as distribution box which distributes the secondary sodium (represented as a solid line) in a bundle of tubes 162. It also comprises an annular dividing wall 163 which defines, around the bundle of tubes 162, a cavity 164 with windows 17 in the upper portion and windows 18 in the lower portion. Thus, in other words, the intermediate exchanger 16 represented in FIG. 2A, is constituted of a bundle of tubes 162 in which flows the secondary sodium and between which the primary sodium flows between the tubes 162.

The secondary sodium enters the central tube, passes through the exchanger, and emerges at the bottom of the exchanger in the distribution box 161. Thanks to this box, the sodium supplies all of the tubes of the bundle of tubes 162 then comes out again at the level of an outlet collector.

The primary sodium enters the exchanger through an inlet window 17 situated in the upper part of the exchanger, passes between the tubes and gives up its heat to the secondary sodium. It comes out through an outlet window 18 situated in the lower part of the exchanger.

The dimensioning constraints of such a component 16 are, according to the prior art:
the transfer of the power required for the desired criteria of inlet and outlet temperatures of the primary sodium and the secondary sodium,
the head loss on the primary side must be compatible with the driving head for the flow of the sodium: gravity flow between the hot collector 12 and the cold collector 14 with a driving head of around 2 m,
the length of the exchange area must be compatible with the height of the vessel 13, with the inlet window 17 of the intermediate exchanger 16 immersed in the hot collector 12.

Thus, the lay out of each intermediate exchanger 16 in the vessel 13 is such that it extends vertically and that its lower portion passes through the redan 15. More precisely, the windows 18 of the lower part of the intermediate exchanger(s) 16 are situated in the cold collector 14. The path followed by the primary sodium is shown schematically in dotted lines in FIG. 2. The primary sodium thus enters each intermediate exchanger 16 via its inlet windows 17 situated in the hot collector 12. In following the tubes 162 of the intermediate exchanger(s) 16, it gives up its heat to the secondary sodium, and comes out of the intermediate exchanger via the windows 18. In the cold collector 14, the sodium is sucked up by pumping means 19 and is sent directly to the inlet of the core 11, in other words below it. The pumping means 19 are constituted of electromechanical pumps, the shaft 190 of which extends vertically substantially over the whole height of the vessel 13 from the core 11 and passes through the covering slab 24. The flow of the sodium in the intermediate exchanger(s) 16 thus takes place uniquely by gravity between the hot collector 12 and the cold collector 14. For reasons of dimensioning of the intermediate exchanger(s) and geometric size, the driving head of the primary sodium Cm between the two collectors 12, 14 is calibrated to a value of around 2 m corresponding to the difference H of level between that 20 of the hot collector 12 and that 21 of the cold collector 14.

To date, for reasons of maximum convection efficiency, optimum sealing must be provided between the components (intermediate exchanger(s) 16 and pumping means 19) and the cylindrical-conical redan 15. In FIG. 2, the sealing must thus be optimal at the level of the crossings 22 and 23. The sealing must thus be optimal to avoid a by-pass of a portion of the primary sodium from the hot collector 12 directly to the cold collector 14 without passing through the intermediate exchanger(s) 16.

The redan 15 is an essential component of SFR reactors of integrated type known to date. It is constituted of a single wall separating the hot collector 12 from the cold collector 14. As specified above and shown in FIG. 2, its general shape is cylindrical-conical. The conical part 15a situated in the lower part of the redan, is traversed by the large components (the intermediate exchangers 16 and the pumps 19, 190). The cylindrical part 15b is a vertical shell situated in the upper portion of the redan. The redan 15 is a part generally formed by mechanical welding and is difficult to design for the following reasons:
its shape and its size are consequent (of the order of fifteen or so metres for a thermal reactor of 3600 MW, of the type used in the EFR project),
the pressure difference that it undergoes between the two collectors 12, 14 during normal operation of the reactor is very considerable (of the order of two metres of sodium column),
the thermo-mechanical constraints due to the temperature differences between hot 12 and cold 14 collectors during normal operation of the reactor are consequent (of the order of 150° C. for present reactors),
the sealings to be realised at the level of the crossings 22, 23 of the redan in its conical portion 15a by the intermediate exchangers 16 and the electromechanical pumps 19, 190 are extremely restrictive: in fact, in the event of a sealing fault at the level of said crossings, there is a high risk of having a by-pass of the intermediate exchanger 16, in other words a portion of the flow of sodium from the hot collector 12 to the cold collector 14 at the level of non sealed crossings. In addition, the sealing means chosen must enable the dismantling of components (intermediate exchangers 16, electromechanical pumps 19) with a view to their maintenance and enable the differential movements of several centimetres due to thermal expansions between components.

Moreover, outside of normal operation, the designers of nuclear power reactors must take into account the situation of reactor shut down: all of the reactors must thus have available systems charged with evacuating the residual power from the core. This residual power stems from the radioactive decay of fission products which have been created during nuclear reactions when the reactor was under power (normal operation). For reasons of safety and in order to ensure the greatest possible redundancy, these circuits must be different as far as possible to the normal circuit for evacuating the thermal power when the reactor is under power: they must not use the steam generator into which emerges the secondary sodium which extracts the heat of the primary sodium. The general architecture of the decay heat removal systems must moreover be compatible with the normal operation of the reactor. Generally, these decay heat removal means are only brought into action when the reactor is stopped.

Thus, the means for evacuating residual power common to most realisations or projects comprise several specific exchangers dedicated to the function of removal of the decay heat. These exchangers 25 are vertical and pass through the covering slab 24 of the reactor. By virtue of their assigned function in the reactor, these exchangers 25 have a smaller size than the intermediate exchangers 16. To be efficient, particularly in the event of failure of the electromechanical pumps 19, the primary sodium must be able to flow by natural convection between the core 11 and the exchangers 25 for removing decay heat. Yet, generally speaking, the reliability and efficiency of natural convection entails the definition of the most simple possible hydraulic path, which may be achieved by complying with the following recommendations:
the hot source (here the core 11 of the nuclear reactor) must be situated in the lower portion,
the cold source (here the exchanger dedicated to the removal of the decay heat 25) must be situated in the upper portion,
the hydraulic path constituting the hot column, situated between the outlet of the hot source and the inlet of the cold source, must be as monotonous as possible (no altimetric variation),
the hydraulic path constituting the cold column, situated at the outlet of the cold source and the inlet of the hot source, must be as monotonous as possible (no altimetric variation),
the hot column and the cold column must be separated to avoid mixing of the heat conveying sodium between the two columns.

Yet, in SFR sodium cooled reactors of integrated type known to date, the exchangers 25 dedicated to the removal of decay heat are situated either in the hot collector 12 or in the cold collector 14. Whatever its position, the hydraulic path of the primary sodium passes through the intermediate exchanger with altimetric variations on the hot and/or cold columns, thus degrading the hydraulic performance of the natural convection. Thus, as illustrated in FIG. 2, the exchangers 25 are fully situated in the hot area or in other words hot collector 12. The hydraulic path is constituted of the hot column represented schematically by the arrow in solid lines 26 and the cold column 27 represented by the arrow in dotted lines 27. Thus, in this FIG. 2, the hot column 26 rises regularly, the altimetric variation is monotonous. On the other hand, the cold column 27 comprises a non-monotonous altimetric variation, since the primary sodium at the outlet of the exchanger 25 must rise in the hot collector 12 (illustrated by the portion 27a of the arrow 27) before entering into the intermediate exchanger 16 to rejoin the core 11 after having passed through an electromechanical pump 19. In the hot collector 12, the hot column 26 and the cold column 27a are not physically separated. This is not an optimum design of the natural convection, since the colder primary sodium coming out of the exchanger 25 can mix in the hot collector 12 with the hotter primary sodium entering this same exchanger 25.

An immediate improvement that could come to the minds of those skilled in the art would consist in putting the exchangers 25 dedicated to the removal of the decay heat between the hot collector 12 and the cold collector 14 through the redan 15, as is the case for the intermediate exchangers 16 with their crossings 22. Yet, this cannot be realised because during normal operation, it would come down to constituting necessarily a by-pass of the intermediate exchangers 16 by the exchangers 25 dedicated to the removal of decay heat, in other words necessarily with a portion of the primary sodium passing between the exchangers 25. The inevitable consequence would be to degrade the performances of the reactor during normal operation.

There thus exists, to date, an intrinsic technical contradiction between the circuit for removing power during normal operation from the core and the circuit for removing the decay heat while stopped and electromechanical pumps since the technical solutions retained which optimise the power evacuation during normal operation degrade the decay heat removal, and vice versa.

A final drawback of sodium cooled SFR reactors of integrated type known to date resides in the considerable size of the vessel. This considerable size is linked to the constraint of placing inside said vessel all of the components of the reactor necessary both for its normal operation and its operation while stopped, particularly the integrated exchangers 16, 25, the electromechanical pumps 19, the internal structures necessary for the definition of hydraulic paths. FIG. 2B represents a reactor of the EFR project in top view of the covering slab 24. In this figure are represented in solid lines the holes needed for the passage of the main components and in dotted lines the lay out of the core 11 and the cylindrical part 15b of the redan 15. Thus may be distinguished spread out on the periphery of the vessel, six identical intermediate exchangers 16, three electromechanical pumps 19 for the flow of sodium in the vessel 13 during normal operation and six exchangers 25 dedicated to the decay heat removal.

This type of architecture thus implies a vessel of large size, which is disadvantageous for the construction cost of the reactor. For the EFR project reactor as illustrated in FIG. 2B, the diameter of the vessel is around 17 m.

The inventors have thus reached the conclusion that even if SFR reactors of integrated type have important advantages in terms of safety compared to SFR loop type reactors, they intrinsically have several drawbacks that can be resumed in the following manner:
a difficult design and realisation of the redan between the hot collector and cold collector,
a delicate compatibility between normal operation under forced convection and operation under natural convection of the removal of the decay heat when the electromechanical pumps are malfunctioning,
a large size of vessel, which penalises the concept from an economical point of view.

The aim of the invention is to resolve at least in part the problems posed by the realisation of sodium cooled fast reactors (SFR) of integrated type, as described above.

More specifically, an aim of the invention is to propose a sodium cooled nuclear reactor (SFR) of integrated type which is compact and the design of which enables it to be cheaper to build while improving safety in the event of failure of the pumping means enabling forced convection.

### DESCRIPTION OF THE INVENTION

According to the invention, this objective is attained by an SFR nuclear reactor of the integrated type, comprising a vessel adapted to be filled with sodium and inside of which are provided a core, pumping means for the flow of the primary sodium, first heat exchangers, known as intermediate exchangers, adapted to evacuate the power produced by the core during normal operation, second heat exchangers adapted to remove the decay heat produced by the core while stopped when the pumping means are also stopped, a separation device defining a hot area and a cold area in the vessel, characterised in that:
the separation device is constituted of two walls each with a substantially vertical portion provided surrounding the core and a substantially horizontal portion, the substantially horizontal portions being separated from each other by a height and the space defined above the horizontal portion of the upper wall forming the hot area whereas the space defined below the horizontal portion of the lower wall forms the cold area and the substantially horizontal portions are provided with clearances in relation to the vessel,
the intermediate exchangers are arranged substantially vertically with clearances in first cuts made in each horizontal wall of the separation device so as to localise their outlet windows below the horizontal portion of the lower wall,
the pumping means with variable flow are divided into two groups hydraulically in series, one provided below the horizontal portion of the lower wall for the flow of the sodium from the cold area to the hot area through the core, the other provided next to intermediate exchangers for the flow of the sodium from the hot area to the cold area through the intermediate exchangers,
temperature acquisition means are provided in the space defined between the horizontal portions of the two walls in being spread out according to a substantially vertical axis to determine in real time the thermal stratification in this space,
automatic control means connected on the one hand to the temperature acquisition means and on the other hand to two pumping groups are provided to modify if necessary the flow of at least one pumping group in order to maintain a satisfactory level of stratification during normal operation,
the second exchangers are arranged substantially vertically above the cold area,
means to enable the natural convection of the primary sodium from the second exchangers to the cold area when the core and the pumping means are also stopped,
all of the clearances and the height between walls of the separation device are previously determined so as, during normal operation, to take up differential movements between the walls, exchangers and vessel and to make it possible to establish during normal operation a thermal stratification of the primary sodium in the space defined between the horizontal portions of the two walls and to reduce, in case of an unexpected stop of a single pumping group, the mechanical stress applied to the walls due to the portion of the primary sodium flow passing between said clearances.

“Satisfactory stratification” level is taken to mean, within the scope of the invention, that as a function of the power rating of the reactor, it is sought in the inter-wall space to obtain a determined temperature profile over its height, preferably with uniform temperature variations, and to maintain the hottest temperature (in the immediate proximity of the horizontal portion of the upper wall) and the coldest temperature (in the immediate proximity of the horizontal portion of the lower wall) at predetermined values and stable over time.

Thus, the invention provides firstly that the separation device otherwise known as redan, between the hot area and the cold area, is constituted of two walls of different dimensions each cut with a substantially vertical portion provided surrounding the core and a substantially horizontal portion in which the heat discharge components are provided with clearances. This goes against the separation devices known as redans of the prior art with single wall in which are provided in as sealed a manner as possible the heat evacuation components.

This design according to the invention with double cut wall makes it possible to resolve the problem of compatibility between the hydraulic path for the natural convection when the pumping devices are malfunctioning and the hydraulic path for the forced convection during normal operation. Thus, during normal operation, the indispensable separation between hot area and cold area is obtained not by physical sealing but by the creation of a “calm area” with very low flow velocity where a thermal stratification establishes itself, this area being situated between the two walls of the separation device, in other words between the hot collector and the cold collector which are areas where the flows have high velocities. In decay heat removal operation, the natural convection is improved, because the hydraulic path between the core and the exchanger dedicated to the removal of the decay heat is simpler: the transfer of the sodium from the hot collector to the cold collector takes place directly through the walls with cuts. This also goes against the solutions retained in the prior art, according to which the transfer of sodium from the hot collector to the cold collector takes place necessarily through the intermediate exchangers.

Another important advantage of the design according to the invention is its facility of realisation for the following reasons:
the separation device is constituted of two walls having simple shapes advantageously of upside down L shape (no conical shell), the “calm” area of flow being defined at the top and bottom by the horizontal portions of the upside down L,
the top face of the upper wall is isothermal since subjected to the hottest sodium, the bottom face of the lower wall is also isothermal since subjected to the coldest sodium,
there is no longer sealing to be realised at the level of the components passing through the walls of the separation device between hot area and cold area,
the vertical shell of the redan present in SFR reactors of integrated type of the prior art is eliminated,
there is no longer any pressure difference between each face of the separation device due to the cuts in the two walls of the latter.

In the design according to the invention, those skilled in the art ensure that the section of the cuts in the walls constituting the separation device and thus the clearances with the different components passing through them is:
sufficiently large so that during an abnormal operation such as an unexpected complete stop of one of the two groups of pumping means, the velocities through the clearances defined between cuts and components do not induce too high mechanical stresses on the walls constituting the separation device,
sufficiently small so that during normal operation of the reactor the velocities of parasitic flows do not perturb the thermal stratification in the calm area defined between the two walls of the separation device,
provided to define a small hydraulic diameter (preferably less than around 1% of the diameter of the vessel) to reduce parasitic flows through the clearances.

The invention thus proposes an improvement of the heat exchange in the intermediate exchangers thanks to the use of two groups of pumping means hydraulically in series, one for the flow of sodium from the cold area to the hot area through the core, the other for the flow of sodium from the hot area to the cold area through the main heat exchangers or otherwise known as intermediate exchangers. These pumping means thus make it possible to make the intermediate exchangers operate in forced convection instead of natural convection by gravity. The size of the sub-assembly constituted of the intermediate exchangers and pumping means is thus reduced compared to the diameter of the same sub-assembly under natural convection in SFR reactors of integrated type according to the prior art.

According to the invention, there is thus a synergic effect between the design of the separation device between hot area and cold area by means of two separate walls with cuts and the use of pumping means to realise a forced convection in the intermediate exchangers. Such a synergic effect contributes to improving the heat exchange performance in the intermediate exchangers.

According to the invention, the means to enable the natural convection of the primary sodium from the second exchangers to the cold area when the core and the pumping means are also stopped may be constituted uniquely of the clearances of a portion between the walls of the separation device and the vessel and on the other hand between the first exchangers and the first cuts. These means of natural convection of the primary sodium from the second exchangers may also be constituted in addition by additional cuts (hereafter second and third cuts) made in the walls of the separation device if the head losses induced by the clearances mentioned above are too high, in other words when said head losses reduce the flow generated by natural convection from the second exchangers to a sufficient level.

The means of acquisition of physical parameters enabling the calculation of the stratification, the automatic control means between the two pumping groups hydraulically in series make it possible to maintain a satisfactory level of thermal stratification.

According to one embodiment, the group of pumping means provided next to the intermediate exchangers for the flow of the sodium from the hot area to the cold area through the intermediate exchangers is downstream of them.

According to another embodiment, the group of pumping means provided next to the intermediate exchangers for the flow of the sodium from the hot area to the cold area through the intermediate exchangers is upstream of them.

Advantageously, the group of pumping means provided next to the intermediate exchangers for the flow of the sodium from the hot area to the cold area through the intermediate exchangers comprises electromagnetic pumps and/or rotodynamic pumps devoid of volute.

According to a preferred variant of an embodiment of the invention, the electromagnetic pumps and/or the rotodynamic pumps devoid of volute provided next to the intermediate exchangers, upstream or downstream of them for the flow of the sodium from the hot area to the cold area are moreover arranged in closed circuit with the inlet windows of the intermediate exchangers.

Again preferably in the case where the electromagnetic or rotodynamic pumps are placed upstream of the intermediate exchanger, at least one electromagnetic or rotodynamic pump is fixed by being placed in the direction of its height against the outer casing of an intermediate exchanger separating the inlet and outlet windows and wherein a conduit directly connects the outlet of the pump and one of the inlet windows of the intermediate exchanger.

Preferably again in the case where the electromagnetic pumps are placed downstream of the intermediate exchanger, at least one electromagnetic pump is fixed in being placed in the direction of its height against the outer casing of an intermediate exchanger separating the inlet and outlet windows and wherein a conduit directly connects one of the outlet windows of the exchanger and the inlet of the pump.

Advantageously, the group of pumping means provided below the lower wall for the flow of the sodium from the cold area to the hot area through the core comprises electromagnetic pumps.

According to a preferred variant of an embodiment of the invention, the electromagnetic pumps provided below the lower horizontal wall for the flow of the sodium from the cold area to the hot area through the core are moreover provided in the core support.

Advantageously, the electromagnetic pumps provided in the core support are moreover arranged substantially directly in line with the intermediate exchangers.

The inventors have reached the conclusion that electromagnetic pumps or rotodynamic pumps devoid of volute are perfectly adapted to operate in a hostile environment and have the advantage of being compact in diameter and in height. They thus meet particularly the criterion of minimisation of the size of the components contained in the vessel of the reactor. In addition, these types of pumping means are perfectly adapted to the variation of the flow by varying the electrical frequency of their supply.

It goes without saying that a same pumping group may comprise a plurality of electromagnetic pumps and/or rotodynamic pumps devoid of volute and that they are then arranged hydraulically parallel to each other.

Also, thanks to the invention the vessel diameter may be reduced.

Indeed, the pumping means of the prior art may be moved and placed under the intermediate exchangers due to the use of electromagnetic pumps.

Even if the width of a sub-assembly constituted by an intermediate exchanger and one or more electromagnetic pump(s) placed against them is azimuthally larger than an intermediate exchanger alone, the fact of eliminating the electromechanical pumps according to the prior art and consequently the size specific to these electromechanical pumps (shafts passing through the vessel from the covering slab) and the space separating them makes it possible to reduce the vessel diameter.

It is possible thanks to the invention to place the electromagnetic pumps according to the invention directly in line below mixed modules (intermediate exchangers/electromagnetic pumps or rotodynamic pumps devoid of upper volute) for the following reasons:
the convection in each intermediate exchanger is no longer under natural convection by gravity but under forced convection by the electromagnetic pumps in the hot area, and the inlet of the sodium in the bundle of tubes on the primary side of the exchanger, is no longer linked to the altimetric position of the latter. Thus, in the sub-assembly of the invention constituted of an intermediate exchanger and an electromagnetic pump or rotodynamic pumps in closed circuit with one of its inlet windows, the inlet of the primary sodium may be situated advantageously at the bottom of the hot collector, and thanks to the forced convection, the inlet window of the bundle of tubes of the exchanger may be situated above the free level. Such a lay out makes it possible to slightly raise the exchanger towards the covering slab of the vessel and thus to free space under it to place the electromagnetic pumps or rotodynamic pumps devoid of volute which make sodium flow from the cold area to the hot area during normal operation,
due to the compactness of electromagnetic pumps or rotodynamic pumps devoid of volute, the choice of the number of pumps and their position is made preferably so as to choose an optimal lay out. In a preferred manner, a sub-assembly constituted of a certain number of electromagnetic pumps provided in the core support may be included in a section directly in line with that defined by a sub-assembly constituted of a single intermediate exchanger and pumps fixed and placed against it. Thus, in the embodiment illustrated in FIG. 3B and as explained hereafter, five identical lower electromagnetic pumps are situated in a section directly in line with a section defined by four fixed pumps placed against a single intermediate exchanger,
a given mixed module (intermediate exchanger/set of upper electromagnetic pumps) is slightly less wide radially than the diameter of an intermediate exchanger according to the prior art.

According to an advantageous characteristic, when the straight section of the lower electromagnetic pumps is greater than the straight section of an intermediate exchanger, the latter then comprises two transversal flanges separated from each other by a distance that corresponds to the height separating the two horizontal portions of the walls, the flanges each being provided opposite said horizontal portions defining the clearances between intermediate exchanger and walls.

The lay out of the electromagnetic pumps in the core support advantageously makes it possible to direct the primary sodium at the outlet from said pumps to the base of the fuel assemblies constituting the core. This base has openings intended to supply the fuel assemblies with sodium.

According to an advantageous variant of an embodiment, the electromagnetic pumps are connected as a set to an intermediate exchanger by means of a flexible link, the flexibility of said link making it possible both to accommodate differential expansions between the intermediate exchanger and the set of electromagnetic pumps and to realise a simultaneous assembly or dismantling of the intermediate exchanger and the set of electromagnetic pumps by push or pull force from the exterior top of the covering slab of the vessel.

The flexible links may moreover be dimensioned to serve as housings to the electric power supply cables of the electromagnetic pumps provided in the core support.

According to an advantageous embodiment of the invention, the temperature acquisition means in the space defined by the two walls are constituted of thermocouples fastened to one or more booms at different levels, the boom(s) being provided(s) substantially vertically and extractible from the exterior top to the covering slab of the vessel.

Preferably, the second exchangers are provided with clearances at least in second cuts made in the horizontal portion of the upper wall of the separation device so as to localise their outlet windows below them.

Again preferably, the outlet windows of the second exchangers are arranged immediately below the horizontal portion of the upper wall in the hottest height of the stratification established between the two horizontal portions.

Also preferably, third cuts made in the horizontal portion of the lower wall are provided directly in line with second cuts in which are provided individually the second exchangers in order to further improve the natural convection of the primary sodium when the core and the pumping means are stopped.

The invention also relates to a thermal convection module comprising a heat exchanger and at least one electromagnetic pump or a rotodynamic pump devoid of volute fixed in being placed in the direction of its height against the outer casing of said intermediate exchanger separating the inlet and outlet windows and in which a conduit directly connects the outlet of the pump and one of the inlet windows.

All of the improvements in the design of a SFR reactor of integrated type obtained thanks to the invention make it possible to optimise the use of the space situated inside the diameter of the vessel and thus to reduce the vessel diameter and consequently of reducing the investment costs.

### BRIEF DESCRIPTION OF DRAWINGS

Other advantages and characteristics of the invention will become clearer on reading the detailed description of the invention made in reference to the following figures, in which:

FIG. 1 is a schematic longitudinal sectional view illustrating the design principle of an SFR loop type reactor according to the prior art,

FIG. 2 is a schematic longitudinal sectional view of an SFR reactor of integrated type illustrating its design principle according to the prior art,

FIG. 2A is a schematic longitudinal sectional view of an intermediate exchanger as provided in FIG. 2 and illustrating its operating principle according to the prior art,

FIG. 2B is a schematic top view of an SFR reactor of integrated type according to FIG. 2 and illustrating the lay out of its components according to the prior art,

FIG. 3 is a schematic longitudinal sectional view of an SFR reactor of integrated type illustrating its design principle according to the invention,

FIG. 3A is a schematic longitudinal sectional view of an intermediate exchanger module with electromagnetic pumps as provided in FIG. 3 and illustrating its operating principle according to the invention,

FIG. 3B is a schematic top view of an SFR reactor of integrated type according to FIG. 3 and illustrating the lay out of its components according to the invention inside the vessel,

FIG. 3C is a schematic top view of a portion of FIG. 3B and illustrating the relative lay out between components,

FIG. 4 is a schematic perspective view showing an electromagnetic pump contributing to the realisation of the invention,

FIG. 5 is a schematic partial longitudinal sectional view of an SFR reactor of integrated type according to the invention illustrating the relative lay out between electromagnetic pumps and intermediate exchanger,

FIG. 5A is a detailed view of FIG. 5 illustrating the lay out of an electromagnetic pump for the flow of the sodium from the cold area to the hot area through the core,

FIG. 6 is a schematic partial longitudinal sectional view of an SFR reactor of integrated type according to the invention illustrating the relative lay out between exchangers dedicated to the discharge of residual power, temperature acquisition means and separation device between hot area and cold area according to the invention,

FIG. 7 is a schematic partial longitudinal sectional view of an SFR reactor of integrated type according to the invention illustrating a variant of lay out between electromagnetic pumps and intermediate exchanger,

FIG. 8 represents the schematic diagram of the chain for regulating the flow of the electromagnetic pumps according to the invention,

FIG. 9 shows an embodiment of an SFR reactor according to the invention, which is an alternative to the embodiment of FIG. 3,

FIG. 9A is a detailed view of FIG. 9,

FIG. 10 illustrates the operating principle of a rotodynamic pump that could be used within the scope of the invention,

FIG. 11 is a schematic longitudinal sectional view of an intermediate exchanger module with rotodynamic pumps illustrating its operating principle according to the invention, which is an alternative to the module according to FIG. 3A,

FIGS. 11A and 11B are detailed views of FIG. 11.

### DETAILED DESCRIPTION OF SPECIFIC EMBODIMENTS

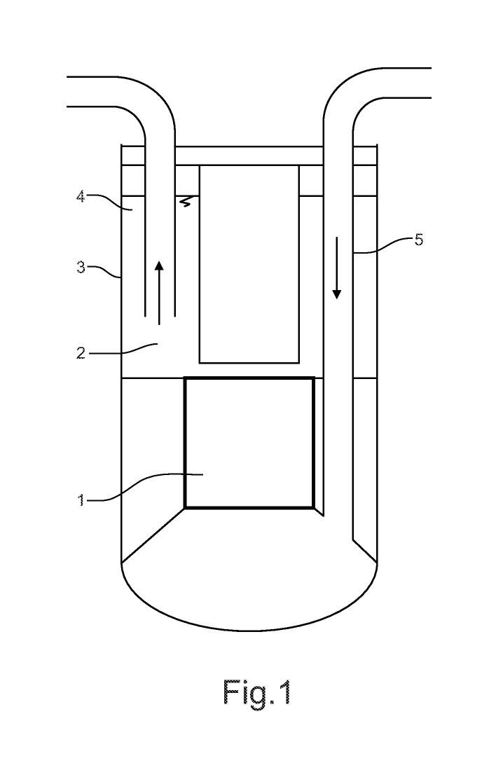

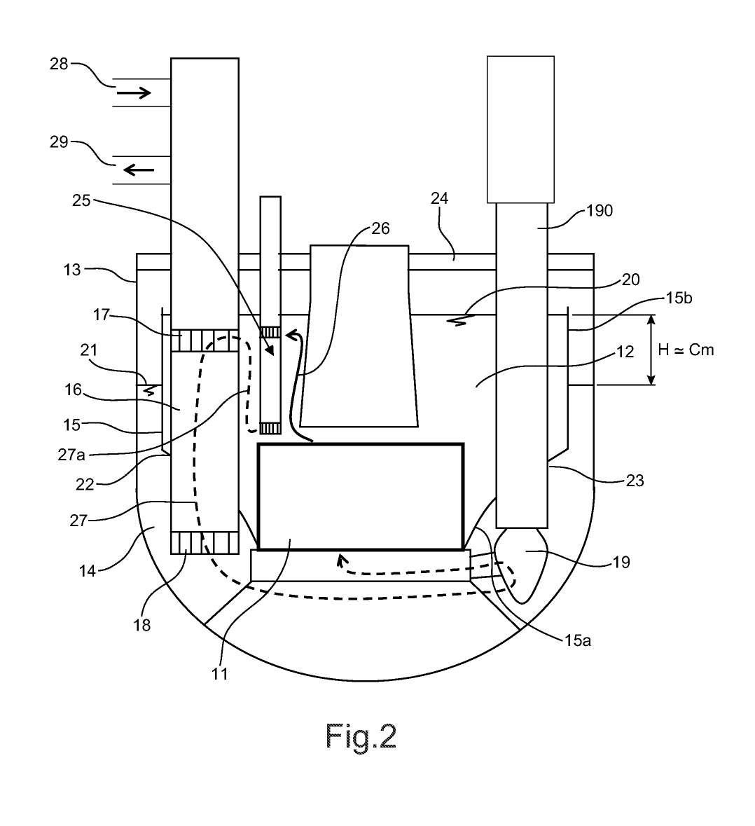

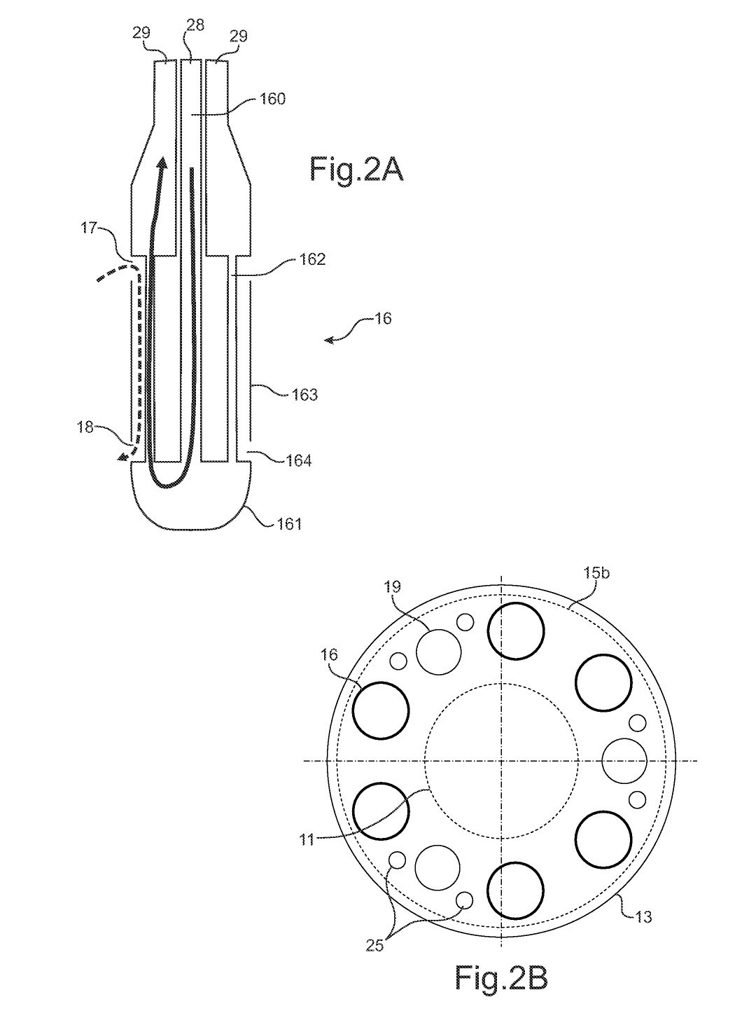

FIGS. 1 to 2B relate respectively to an SFR loop type reactor according to the prior art and an SFR reactor of integrated type according to the prior art. They have already been explained above and will thus not be explained hereafter.

For reasons of clarity, the same references designate the same components common to a SFR reactor of integrated type according to the prior art and illustrated in FIG. 2 and an SFR reactor of integrated type according to the invention.

Throughout the present application, the terms “horizontal”, “vertical”, “lower”, “upper”, “below” and “above” should be understood with reference to a vessel of the reactor arranged vertically and to the lay out in relation to the cold or hot area. Thus, the upper wall according to the invention designates the wall the closest to the hot area, whereas the lower wall designates that closest to the cold area. Similarly, an electromagnetic pump according to the invention provided below the lower wall is that situated in the cold area.

Similarly, throughout the present application, the terms “upstream” and “downstream” should be understood with reference to the direction of the flow of sodium. Thus, a group of pumping means upstream of an intermediate exchanger is traversed firstly by the sodium which then flows through the intermediate exchanger. A group of pumping means downstream of an intermediate exchanger is traversed by the sodium which has passed through the intermediate exchanger beforehand.

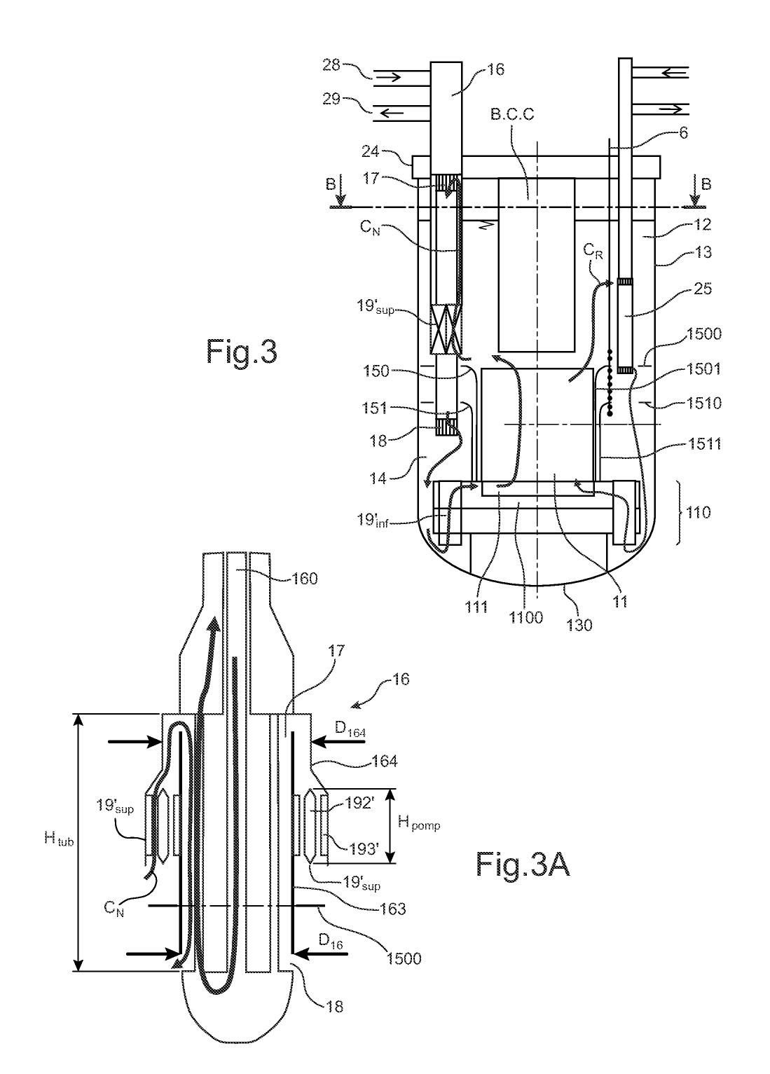

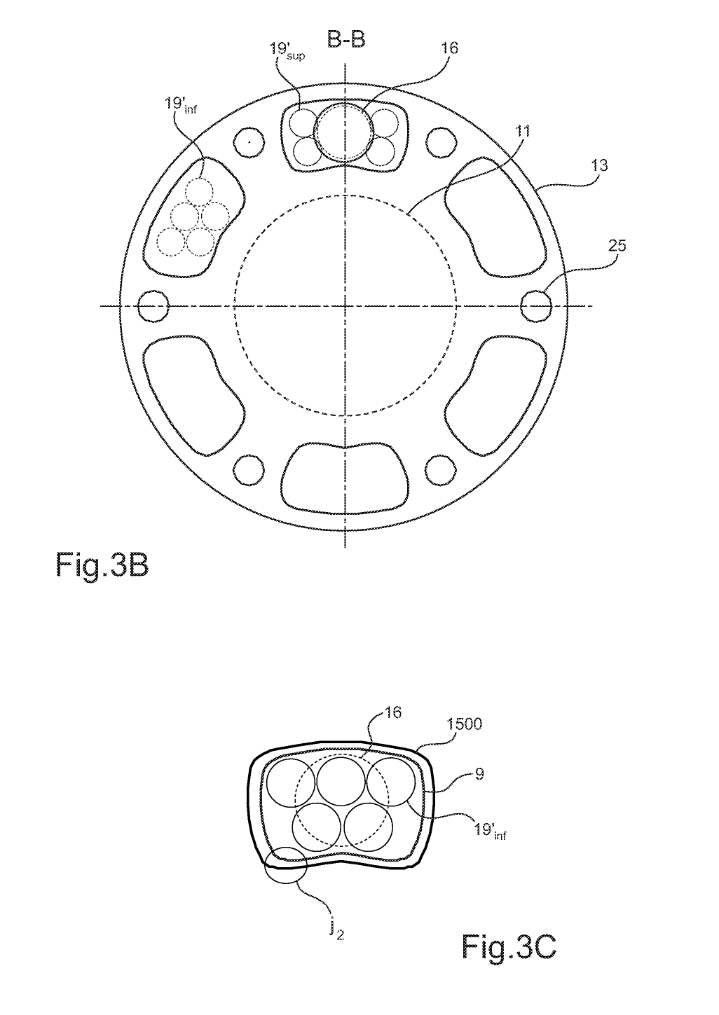

In FIG. 3 may be seen the overall diagram of an SFR reactor of integrated type according to the invention. The integrated reactor comprises a core 11 in which heat is released following nuclear reactions. Said core 11 is supported by a support 110. This support 110 comprises a diagrid 1100 in which are sunk the bases of assemblies 111 constituting the core, this diagrid 1100 being supported by a decking 1101 resting on the bottom 130 of the vessel 13. Above the core is arranged the core control plug (BCC) comprising the instrumentation necessary for the control and the correct operation of nuclear reactions.

The heat removal circuit followed by the primary sodium during normal operation of the core 11 is schematically represented by the arrows in solid lines CN: at the outlet of the core, the sodium emerges into a hot collector 12. The hot collector 12 is separated from the cold collector 14 underneath by an appropriate separation device 15.

This separation device between hot 12 and cold 14 collectors (or areas) is constituted of two walls 150, 151 with cuts. These two walls 150, 151 with cuts each have a substantially vertical portion 1501, 1511 provided surrounding the core and a substantially horizontal portion 1500, 1510. The horizontal portions 1500, 1510 are separated by a height H. In the embodiments illustrated, they are connected together by a round off. The vertical portions of each wall 150, 151 are fixed to the core support 110 11. The space defined above the horizontal portion 1500 of the upper wall 150 forms the hot area, whereas the space defined below the horizontal portion 1510 of the lower wall 151 forms the cold area.

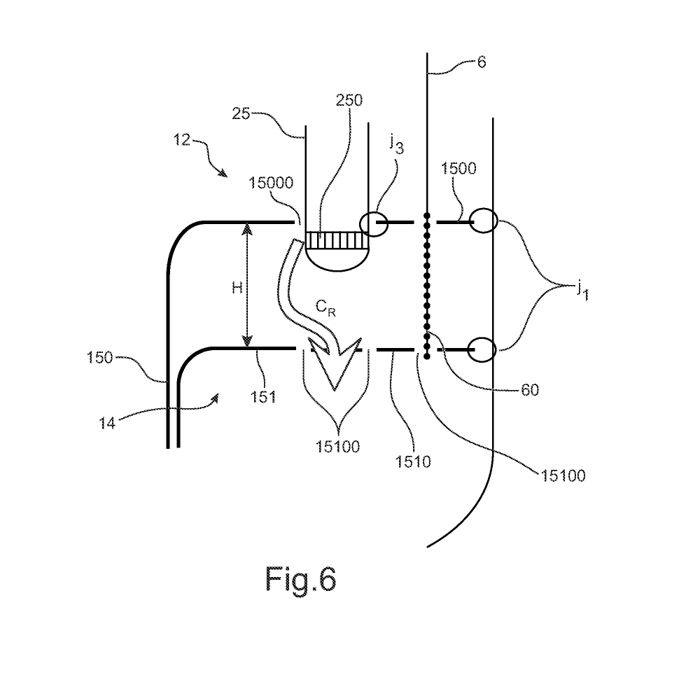

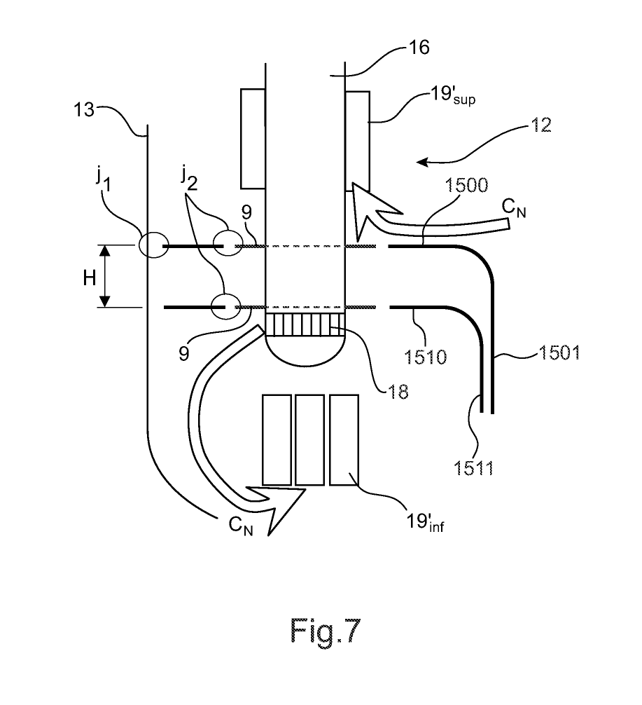

As shown in FIGS. 6 and 7, the substantially horizontal portions 1500, 1510 are provided with clearances j1 in relation to the vessel 13.

Each intermediate exchanger 16 is arranged vertically through the covering slab 24. The primary sodium supplying the intermediate exchangers 16 during normal operation is taken from the hot collector 12 and is expelled into the cold collector 14. The intermediate exchangers 16 pass through the two horizontal portions 150, 151 of wall with a functional clearance j2 and without any particular sealing.

Electromagnetic pumps 19′sup are arranged in closed hydraulic circuit with the inlet of the intermediate exchangers 16 for the flow by forced convection of the sodium in these exchangers.

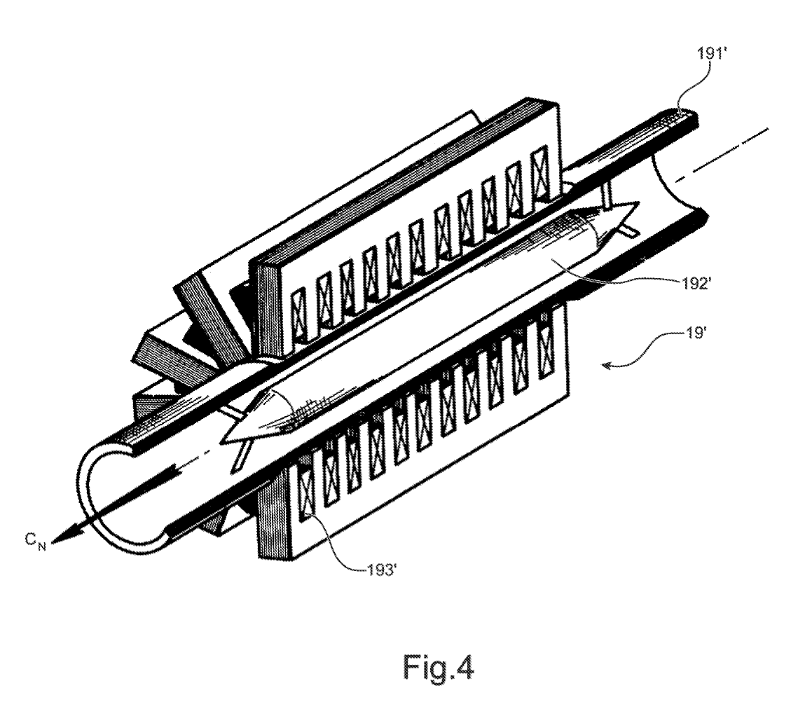

An example of embodiment of electromagnetic pump 19′ conforming to the invention not just for the pumps provided above but also those provided below is represented in FIG. 4. Such a pump 19′ is constituted of an annular channel 191′ forming the sodium ring in which is installed a laminated core ensuring the closing of the magnetic circuit 192′, surrounded by magnetic coils 193′ constituting the external magnetic circuit. Such a pump 19′ uses the conducting properties of sodium to pump it without the intervention of a moving mechanical part. The principle is to create a magnetic field sliding along a sodium ring defined by 191′ and 192′. Induced currents are then created in the ring and with the magnetic field it exerts on the sodium electromagnetic forces known as Laplace forces pushing the sodium in the annular channel according to the direction of flow CN.

In the cold collector, the electromagnetic pumps 19′inf suck up the sodium to push it into the core 11.

The size dimensions of the electromagnetic pumps 19′ are small compared to electromechanical pumps according to the prior art, providing that the flow is not too important, (below one m³/s). To this end, appropriate structures are advantageously provided placed just upstream and downstream of said electromagnetic pumps 19′. The aim of said appropriate structures is to guide the sodium in order to obtain correct supply of the annular channel with minimum head loss.

FIG. 3A presents the preferred variant of the coupling in closed hydraulic circuit between an intermediate exchanger 16 and electromagnetic pumps 19′sup according to the invention. Such a coupling makes it possible in accordance with the effect sought by the invention to obtain a CN flow of primary sodium under forced convection. The driving head is supplied by the fixed electromagnetic pumps 19′sup placed against the outer casing of the intermediate exchanger 16 which separates the inlet windows 17 from the outlet windows 18. More precisely, an annular conduit is provided for supplying the sodium 164 connecting the outlet of the annular channel 191′ of the electromagnetic pumps 19′sup to the inlet windows 17, thus forming a closed circuit. As may also be seen in FIG. 3A, each electromagnetic pump 19′sup is provided slightly above the horizontal portion 1500 of the upper wall 150. The sodium is sucked up by the pumps 19′sup, then is sent to the inlet 17 via the annular supply conduit 164. In the upper part, the sodium enters the inlet windows 17 as for a standard design exchanger.

The advantages of such a modular architecture (intermediate exchanger 16+fixed electromagnetic pumps 19′sup placed around) with forced convection of the primary sodium are:
of improving slightly the overall exchange coefficient of the exchanger,
of reducing the step between the tubes 162 of the primary sodium because the head loss is no longer constrained by the gravitational driving head as in an intermediate exchanger in an SFR reactor according to the prior art,
for a given exchange area, of reducing the number of tubes by increasing their length, because the sucking up of the sodium is always immersed in the hot collector (sucking up by the pumps 19′sup), but the inlet window 17 of the intermediate exchanger 16 may be provided above the free level 20 of the hot collector 12 due to the upwards propulsion of the primary sodium.

The radial size of an intermediate exchanger 16 may thus be reduced.

The lay out of a mixed module 16, 19′sup according to the embodiment of FIG. 3B is preferred: four identical electromagnetic pumps 19′sup and placed two by two on a side diametrically opposite to a given intermediate exchanger 16.

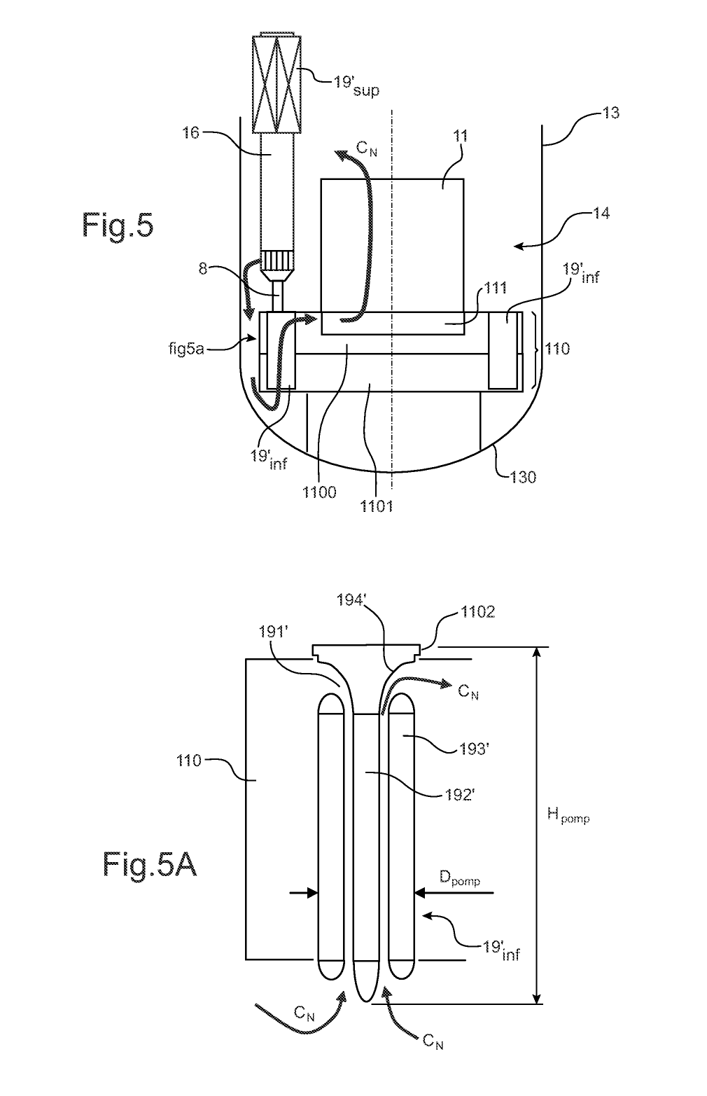

FIGS. 5 and 5A represent respectively a preferred variant of lay out of the electromagnetic pumps 19′inf serving to direct the primary sodium from the cold collector 14 to the core 11 on the one hand compared to a intermediate exchanger 16/electromagnetic pumps 19′sup mixed module and on the other hand compared to the support 110 of the core 11.

The core 11 is cooled by the sodium passing through it. The use of electromagnetic pumps 19′ makes it possible to reduce considerably the height of the pumping means and to place those 19′inf for the flow of primary sodium from the cold area to the core 11 directly in line below intermediate exchangers 16. Thus, under each intermediate exchanger 16/19′sup mixed module is placed a set of one or more electromagnetic pumps 19′inf enabling the primary sodium to flow in the core 11. The number of pumps 19′inf constituting this set will be dependent on the architecture of the reactor. In the variant illustrated in FIGS. 3B and 3C, five lower electromagnetic pumps 19′inf are directly in line with a module comprising an intermediate exchanger 16 and four upper electromagnetic pumps 19′sup placed two by two against one side diametrically opposite the intermediate exchanger 16.

In FIGS. 5 and 5A, the electromagnetic pumps 19′inf are laid on structures known as diagrid 1100 and decking 1101 serving as support 110 for the core 11.

The CN flow of the primary sodium in the annular space of the lower electromagnetic pumps 19′inf is vertical and directed upwards. A counter reaction force of the electromagnetic pump directed downwards ensues, favouring the resting of the electromagnetic pump on its support 110 thanks to a shoulder 1102 situated on the outlet deflectors 194′. The outlet deflector 194′ thus directs the sodium to the bases of the assemblies 111 constituting the core 11.

A set of lower electromagnetic pumps 19′inf is advantageously connected to a mixed module comprising an intermediate exchanger 16 and at least one upper electromagnetic pump 19′sup by a flexible mechanical link 8. The functions of this link 8 are:
to enable the assembly and dismantling of the lower electromagnetic pumps 19′inf at the same time as the assembly and dismantling of intermediate exchangers 16/upper electromagnetic pumps 19′sup mixed modules, by raising or pushing the assembly from the exterior of the slab 24 of the vessel 13,
to make it possible to accommodate differential expansions between a module 16, 19′sup and the lower electromagnetic pumps 19′inf directly in line below,
to serve as guide for the electrical cables necessary for the power supply of the lower electromagnetic pumps 19′inf.

The table below gives the orders of magnitude of a possible example of embodiment:

| | | Symbols | |
|---|---|---|---|
| | Symbols | (in FIG. 5A) | Value |
| Power of the reactor | MW | | 3600 |
| Number of mixed modules 16/19′ sup | | | 6 |
| Number of lower electromagnetic | | | 5 |
| pumps 19′ inf per mixed module | | | |
| 16/19′ | | | |
| Flow through the core 11 | m3/s | | 22.54 |
| Flow per lower electromagnetic | m3/s | | 0.75 |
| pump 19′ inf | | | |
| Head loss of the core 11 | bar | | 5.4 |
| Length of a pump 19′ inf* | m | Hpomp | 3.4 |
| Diameter of a PEM | m | Dpomp | 0.90 |

*Length of the electromagnetic pump 19′ inf corresponds approximately to the length of the coils, the magnetic masses and structures and or deflectors to guide the sodium just upstream and downstream of the annular conduit 191′.

FIG. 6 presents an optimised embodiment to improve the efficiency of the thermal stratification in the space of height H separating the two horizontal portions 1500, 1510 of the upper and lower walls 150, 151 and thus to improve the natural convection Cr (residual flow) of the primary sodium in stopped operation of nuclear reactions. A cut 15000 is provided in the horizontal portion 1500 of the upper wall 150 under each exchanger. The exchange area of the exchangers 25 dedicated to the decay heat removal is entirely placed inside the hot collector. The outlet window 250 is positioned just below the horizontal portion 1500 of the upper wall 150. A functional clearance j3 between the cut 15000 of the upper wall 150 and the exchanger 25 enables differential movement between these components.

The advantages of this lay out during operating mode of removing the decay heat from the core 11 (stopped as well as the electromagnetic pumps 19′), are the following:
since the outlet window 250 of the secondary exchanger 25 is placed just under the horizontal portion 1500 of the upper wall 150, the cold sodium coming out of this exchanger 25 in operation descends more easily to the cold collector 14 since one of the walls 150 has already been surmounted, and this without mixing with the sodium from the hot collector 12, in other words, the hydraulic path during stopped operation under natural convection is improved,
the sodium passes through the horizontal portion 1510 of the lower wall 151 via cuts 15100 made under the exchanger dedicated to the decay heat removal and via the holes constituted by the functional clearances between the lower wall and the intermediate exchangers and the functional clearance between the wall of the redan and vessel of the reactor.

FIG. 7 represents an advantageous variant of embodiment of an intermediate exchanger 16/electromagnetic pumps 19′sup mixed module and its lay out compared to a set of lower electromagnetic pumps 19′inf.

The height H of the space between horizontal portions 1500, 1510 of the two walls 150, 151 is relatively important (of the order of two metres) to enable correct stratification. The distance between the vertical portions 1501, 1511 of the two walls is small (of the order of several centimetres).

The space of height H is in communication with the hot collector 12 and the cold collector 14 through the following functional clearances:
j1 defined between the horizontal portions 1500, 1501 of the two walls and the vessel 13. This functional clearance j1 is of the order of several centimetres and makes it possible to take up the differential movements between the components (walls 150, 151 and vessel 13),
j2 defined at the level of the crossings between intermediate exchangers 16/upper electromagnetic pumps 19′sup mixed modules and walls 150, 151. This functional clearance j2 is of the order of several centimetres and makes it possible to take up differential movements between the components (walls 150, 151 and intermediate exchangers 16),
j3 defined at the level of the crossings between exchangers 25 dedicated to the removal of the decay heat and the horizontal portion 1500 of the upper wall 150. As explained previously, in order that the sodium coming out of these exchangers 25 easily rejoins the cold collector 14, additional cuts 15100 are made directly in line with the horizontal portion 1510 of the lower wall.

To dimension precisely the separation device in a given configuration, those skilled in the art will see to it that the communication spaces do not have sections of passage too important with a large hydraulic diameter in order to form an efficient physical separation. The purpose of the walls is in fact to mark a physical limit between areas 12, 14 where the flows have high velocities: hot collector 12 and cold collector 14, with a calm area where a thermal stratification has to establish itself without there being any necessity to have sealing. As a function of the application of the invention, specific lay outs may be made. Whatever the case, the functional clearances j1, j2 and j3 and the height H between the horizontal portions 1500, 1510 of the two walls of the separation device are previously determined so as to, during normal operation, take up differential movements between the walls 150, 151, exchangers 16, 25 and vessel 13 and to make it possible to establish during normal operation a thermal stratification of the primary sodium in the space defined between the horizontal portions of the two walls 150, 151 and to reduce, in case of an unexpected stop of a single pumping group 19′, the mechanical stress applied to the walls and due to the portion of the primary sodium flow passing between said clearances.

The thermal stratification thereby determined thus consists in a way in providing a sufficiently important volume over the height between the two walls 150, 151 and reducing the parasitic flow of primary sodium between hot area 12 and cold area 14.

By way of indication, an order of magnitude of the section of passage between walls and collectors 12, 14 is given here, under the same conditions as those given in the preceding tables. For this evaluation, the functional clearances at the level of the communications j1, j2 and j3 are estimated at around 5 cm:
functional clearance j1 between the vessel 13 and portions of wall 1500, 1510: with a vessel of diameter 14 to 15 m, the total section is 2.3 m²,
functional clearance j2 between intermediate exchanger 16 and portions of wall 1500, 1510: with six exchangers 16 with lower electromagnetic pumps 19′inf which require a section of passage corresponding approximately to a rectangle of 2×3 m, the section is 3 m²,
functional clearance j3 between the exchanger for removing decay heat 25 and the horizontal portion 1500 of the upper wall 150: with six exchangers 25 of around a meter diameter, the section is ˜1 m².

The total section of passage of the horizontal portion of the upper wall is around 6 m². This total estimation is valid for the upper wall 150. Since the lower wall 151 is not crossed by the exchangers 25 dedicated to the decay heat removal, only the cuts 15100 are formed in the horizontal portion 1510 of this wall. These cuts 15100 preferably have a hydraulic diameter equivalent to the other cuts, i.e. a diameter of around 0.10 m. The number of these cut 15100 is preferably such that their total section is at least equal (in order of magnitude) to the total section created by the functional clearance j3 around the decay heat removal exchangers 25. In the embodiment illustrated, since this section is of the order of 1 m², there will be at least twenty or so cuts 15100 under each exchanger 25 dedicated to the discharge of residual power.

Whatever the case, the section of passage through the walls with cuts 150, 151 is, in order of magnitude, satisfactory for all of the following different operations:
it must be sufficiently large so that the walls 150, 151 do not undergo too high mechanical stress in the event of total unexpected stoppage of a pump group 19′. Indeed, for a reactor of a power rating of the order of 3600 MW, the sodium flow during normal operation is of the order of around 22.5 m³/s. Thus for example, in case of an unexpected stop of the group of pumps 19′sup supplying the intermediate exchangers 16, a portion of the sodium flow continues to flow in the intermediate exchangers 16 and the other portion through the clearances j1, j2, j3 between components 16, 25, 13 and walls 150, 151. The distribution between the two flows is a function of the relative head losses between the intermediate exchangers 16 and the two walls 150, 151. An estimation of these head losses leads potentially to around 70% of the flow passing between the clearances j1, j2, j3 i.e. around 16 m³/s. The average velocity between the cuts in the walls 150, 151 and the components is thus 2.7 m/s. This velocity is low and does not lead to high mechanical stresses on the walls 150, 151,
it is sufficiently large so as not to break the thermal stratification, in other words maintain a vertical temperature profile and highest and lowest temperatures that can always be corrected during normal operation by automatic control of the pumps and maintained in stopped operation,
during normal operation, to limit parasitic flows through the holes, the hydraulic diameter must be small. The sections of passage in the walls 150, 151 are preferably of very long shape with a width of around 5 cm. In this case, the hydraulic diameter is substantially equal to twice the width, i.e. 10 cm. Such a diameter in relation to the diameter of a vessel of a reactor according to the invention, which could be of the order of around 15 m, the relative value of the hydraulic diameter is thus 0.1/15, i.e. less than 0.7%.

A comparative evaluation between two SFR reactors of integrated type each with a thermal power rating of 3600 MW and each comprising six intermediate exchangers 16: the reactor R1 according to the prior art comprises the intermediate exchangers 16 according to FIGS. 2 to 2B, whereas the reactor according to the invention R2 comprises the intermediate exchangers 16 according to FIGS. 3 to 3C.

The following table summarises this comparative evaluation.

| | | Symbols | | |
|---|---|---|---|---|
| | | (FIGS. 3 | | |
| | Units | and 3A) | R1 | R2 |
| Unit power | MW | | 600 | |
| Primary temperatures | ° C. | | 548/398 | |
| Secondary temperatures | ° C. | | 525/345 | |
| Primary sodium flow per | m3/s | | 3.76 | |
| module 16 or mixed | | | | |
| 16/19′ sup | | | | |
| External diameter of tubes | mm | | 17.1 | |
| 162 | | | | |
| Thickness of tubes 162 | mm | | 0.8 | |
| Number of tubes 162 | | | 5022 | 3000 |
| Length of tubes 162 | m | H_{tub} | 8.3 | 10.3 |
| Pitch ratio of the bundle | | | 1.59 | 1.4 |
| (pitch/external diameter) | | | | |
| Overall exchange | W/ | | 38200 | 48000 |
| coefficient | m²° C. | | | |
| Exchange surface in | m² | | 2230 | 1660 |
| relation to the external | | | | |
| diameter | | | | |
| External diameter of the | m | D₁₆ | 2.40 | 1.75 |
| intermediate exchanger 16 | | | | |
| Power volume density of | MW/ | | 19.5 | 34 |
| the bundle of tubes 162 | m³ | | | |
| External diameter of the | m | D₁₆₄ | | 1.96 |
| supply conduit 164 of the | | | | |
| intermediate exchanger 16 | | | | |
| External diameter of an | m | | | 1.03 |
| electromagnetic pump | | | | |
| 19′ sup | | | | |
| Height of the | m | Hpomp | | 1.6 |
| electromagnetic pumps | | | | |
| 19′ sup* | | | | |
| Order of magnitude of head | bar | | 0.17 | 1 |
| loss of the intermediate | | | | |
| exchanger or module 16 | | | | |

*the height Hpomp corresponds approximately to the height of the coils, the magnetic masses and the structures to guide the sodium just upstream and downstream of the annular conduit 164 of the pump 19′ sup.

FIG. 3C and FIG. 7 illustrate moreover an optimised embodiment in the case where the straight section of the set of lower electromagnetic pumps 19′inf is larger than that of the intermediate exchanger 16. This embodiment makes it possible to obtain a crossing of the walls 150, 151 through the intermediate exchanger 16 with a reasonable hydraulic diameter. To deal with the case where flow velocities of the sodium in the hot collector 12 (or the cold collector 14) could induce high velocities (which could possibly break the stratification) through the free space at the level of the section of passage between the intermediate exchanger 16 and the walls 150, 151, a flange 9 is fixed on the intermediate exchanger 16.

The shape of the cuts of the horizontal portions 1500, 1510 of the walls 150, 151 must be slightly greater than the straight section of the set of electromagnetic pumps 19′inf to enable their through passage during assembly/dismantling. When these cuts are too big, flanges 9 are installed in order to reduce the clearance as to obtain the functional clearance j2 described above.

These two flanges 9 are thus fixed on the external shell of the exchanger 16 and are provided at a height such that they are each situated opposite one of the horizontal portions 1500, 1510 of one of the walls 150, 151. The section of these flanges 9 defines with the cuts of the horizontal portions 1500, 1510 of the walls 150, 151 the functional clearances j2 which enable differential movement between components 16, 150, 151 following the thermal expansions undergone. Once again, a functional clearance j2 of several centimetres is necessary.

These flanges 9 have the function of avoiding allowing too great an opening between an area with high flow velocity (the hot 12 or cold 14 collector) and an area of low velocity (the space defined between the horizontal portions 1500, 1510 and the height H). The clearance of the flanges 9 with the cuts is thus determined to be of the order of the functional clearance j2 above.

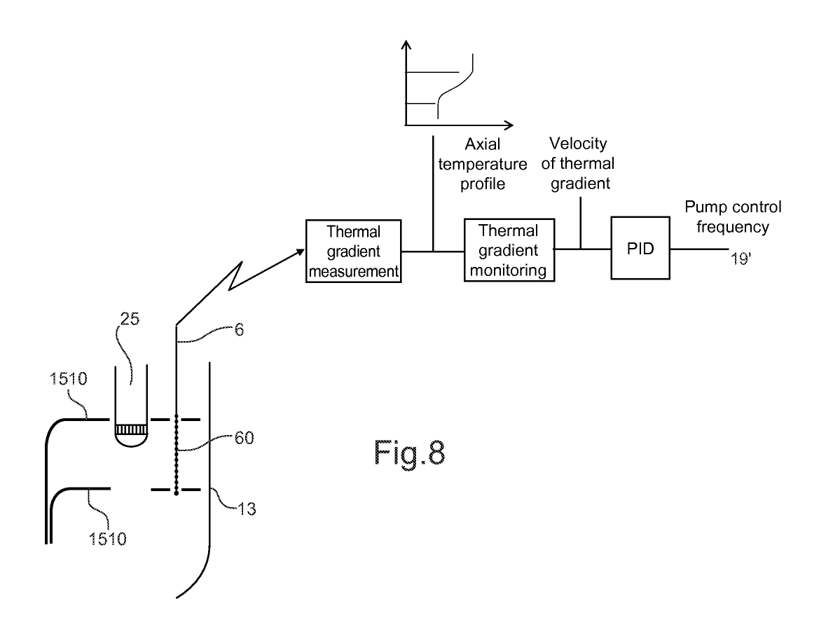

FIG. 8 presents an optimised embodiment for measuring the thermal gradient in the internal space between horizontal portions 1500, 1510 of the wall 150, 151. The temperature acquisition means represented are here constituted of one or more booms 6 immersed in the sodium and passing through the two horizontal portions 1500, 1510 of the two walls 150, 151. On this (these) boom(s) 6 are arranged thermocouples 60 intended to determine the temperature of the sodium at different altitudes in the internal area of height H between walls 150, 151. Knowledge of the vertical temperature profile associated with a numerical treatment makes it possible to monitor the evolution of the thermal gradient and automatically control the flow from one pump group 19′sup or 19′inf to the flow of the other 19′inf or 19′sup.

During normal operation, the flow in the upper electromagnetic pumps 19′sup and the flow in the lower electromagnetic pumps 19′inf are set to be identical. Under these conditions, the area of height H between the two walls 150, 151, constitutes an area without flow or with flows with low velocity enabling the establishment of a thermal stratification.

It is this thermal stratification that serves as separation between the two hot 12 and cold 14 collectors.

The measurement of this thermal stratification by the thermocouples or temperature sensors 60 fixed at different altitudes to the boom(s) or by another method makes it possible if required to adjust the relative flow between group of pumps 19′inf and 19′sup.

The efficiency of the thermal stratification may be evaluated by the Richardson number defined by the following equation:

Ri=g(Δρ/ρ)H/V²

Where:
g is the acceleration due to gravity (9.81 m²/s);
Δρ/ρ is the relative density variation;
Δρ=ρ_{cold}-ρₕₒₜ
ρ_{cold} is the density of the cold fluid;
ρₕₒₜ is the density of the hot fluid;
ρis the average density of the fluids;
H is a dimension characteristic of the volume, typically the height of the volume,
V is the arrival velocity of the fluid in the volume.

The Richardson number Ri thus characterises the ratio between the density or gravitational forces (Δρ g H) with the forces of inertia (ρ V²). If the forces of inertia are greater than the gravitational forces, Ri will be less than one and the forced convection prevails, there is no stratification. If the gravitational forces are greater than the forces of inertia, Ri will be greater than one, which signifies that there is a stratification that establishes itself inside the volume.

In a volume comprising inlets and outlets of hot and cold liquid, it is considered that there is stratification if the dimensionless Richardson number is greater than one.

In the particular case studied, the volume to consider is the space of height H situated between the two horizontal portions 1500, 1510 of the walls 150, 151. Since, during normal operation, the flows of the lower electromagnetic pumps 19′inf and upper 19′sup are equal, there is no flow in this space of height H, thus the velocities are zero. In reality, there can be slight flow because the two walls being cut by means of functional clearances j1, j2, j3, low flow velocities appear through said clearances.

Evaluation of the Richardson Number Ri in a R2 Reactor According to the invention:
Power of the reactor: 3600 MW
Core inlet temperature (cold temperature): ˜390° C.
Core outlet temperature (hot temperature): ˜540° C.
Rated sodium flow ˜22.5 m³/s
Density of the hot Na: ˜821 kg/m³
Density of the cold Na: ˜857 kg/m³
Relative density variation: ˜4.3%
Acceleration due to gravity: 9.81 m/s²
Relative dimension of the volume (corresponding to the height H between the two walls 150, 151): ˜2 m
Section of passage in the walls 150, 151 due to the presence of clearances j1, j2, j3: ˜6 m²

If an important imbalance of temporary flow of 10% is estimated between the two groups of pumps 19′sup and 19′inf, this signifies that there is potentially a 10% flow of the rated flow that passes through the functional clearances j1, j2, j3 i.e. around 2.25 m³/s.

With a section of around 6 m², the velocity is thus around equal to 0.37 m/s.

Under these conditions, the Richardson number Ri is substantially equal to 6. This number being greater than one, the flow in the space between walls 150, 151 of height H is indeed stratified. The level measurement of this stratification thus makes it possible to readjust the relative flows between the two groups of pumps 19′inf and 19′sup by an appropriate regulation.

FIG. 8 represents a method of flow regulation by means of an appropriate regulation chain. The regulation chain comprises the boom 6 on which are fixed the thermocouples 60 in order to measure the temperatures at different altitudes in the space of height H. The thermocouples 60 are connected to a system for analysing the thermal gradient so as to determine the evolution of this gradient and determine the ascending or descending velocity of this gradient. This analysis system is connected to PID regulation, in other words “Proportional Integral and Derived”, which determines the electrical frequency of the electrical supply of a given group of pumps 19′, for example the upper pumps 19′sup if the flow of the intermediate heat exchangers 16 is automatically controlled to be equal to the flow of sodium passing through the core 11.

The analysis of this profile of temperatures and its monitoring over time make it possible to determine the difference in flow between the two groups of pumps.

If the temperature profile is stable, that signifies that the flows of the groups are identical, which is a satisfactory operation.

If the temperature profiles move upwards or downwards, there is a difference in flow between the two groups of pumps. Thus, if the velocity of movement of the profile is 0.01 m/s, the difference in flow is obtained by multiplying this velocity by the section of the internal redan space. For a reactor of 3600 MW, the vessel diameter of which is around 15 m, this section is around 110 m². For the example considered, the difference in flow is 1.1 m³/s i.e. around 5% of the rated flow. In this case, the operating point is not considered as satisfactory and thus the regulation intervenes on the automatically controlled pumps to rebalance the flow and thus bring back the thermal gradient towards the middle of the height between the portions of horizontal walls 1500 and 1510.

An SFR reactor of integrated type according to the EFR project under study (represented in FIG. 2) has a vessel diameter of the order of 17 m.

With the invention proposed, it is possible to attain a vessel 13 diameter of the order of 14.5 m, i.e. a 15% reduction in the diameter of the vessel compared to the prior art.

The reduction in the diameter of the vessel 13 thanks to the invention has been made possible by the elimination on the circumference where are placed the components of the location of three primary electromechanical pumps. The pumping means have according to the invention been able to be moved and placed under the intermediate exchangers 16 due to the use of electromagnetic pumps 19′. Even if the width of a mixed module according to the invention (intermediate exchanger 16/electromagnetic pumps 19′sup) is azimuthally slightly larger than a single intermediate exchanger 16, the fact of eliminating the three electromechanical pumps according to the prior art and the space separating them from the other components (exchangers 16 and 25) makes it possible to reduce the vessel diameter.

The possibility of placing the electromagnetic pumps 19′inf according to the invention directly in line below intermediate exchangers 16/electromagnetic pumps 19′sup mixed modules is due to the following reasons: o the convection in the exchanger is no longer under natural convection by gravity, but under forced convection by pumps, and the entry of the sodium into the bundle of tubes on the primary side is no longer linked to the altimetric position of the intermediate exchanger. In a standard design, the inlet window is necessarily below the free level of the sodium of the hot collector. In the case of the mixed module (intermediate exchanger 16/electromagnetic pumps 19′sup), the sodium inlet is situated at the bottom of the hot collector, and thanks to the forced convection, the inlet window of the bundle of tubes may be situated above the free level, which comes down to slightly raising the exchanger and freeing space under it to place the pumps.
the electromagnetic pumps 19′ are pumps that are compact in diameter and in height: an optimal lay out may thus be chosen (FIG. 3B);
a mixed module (intermediate exchanger 16/electromagnetic pumps 19′sup) is slightly less large than the diameter of an intermediate exchanger 16 according to the prior art. By way of example, a diameter of an intermediate exchanger 16 according to the prior art (FIG. 2A) is of the order of 2.4 m, whereas the radial size of a mixed module 16/19′ is of the order of 1.96 m.
the elimination of the vertical cylindrical portion 15b of the redan of SFR reactors of integrated type according to the prior art.

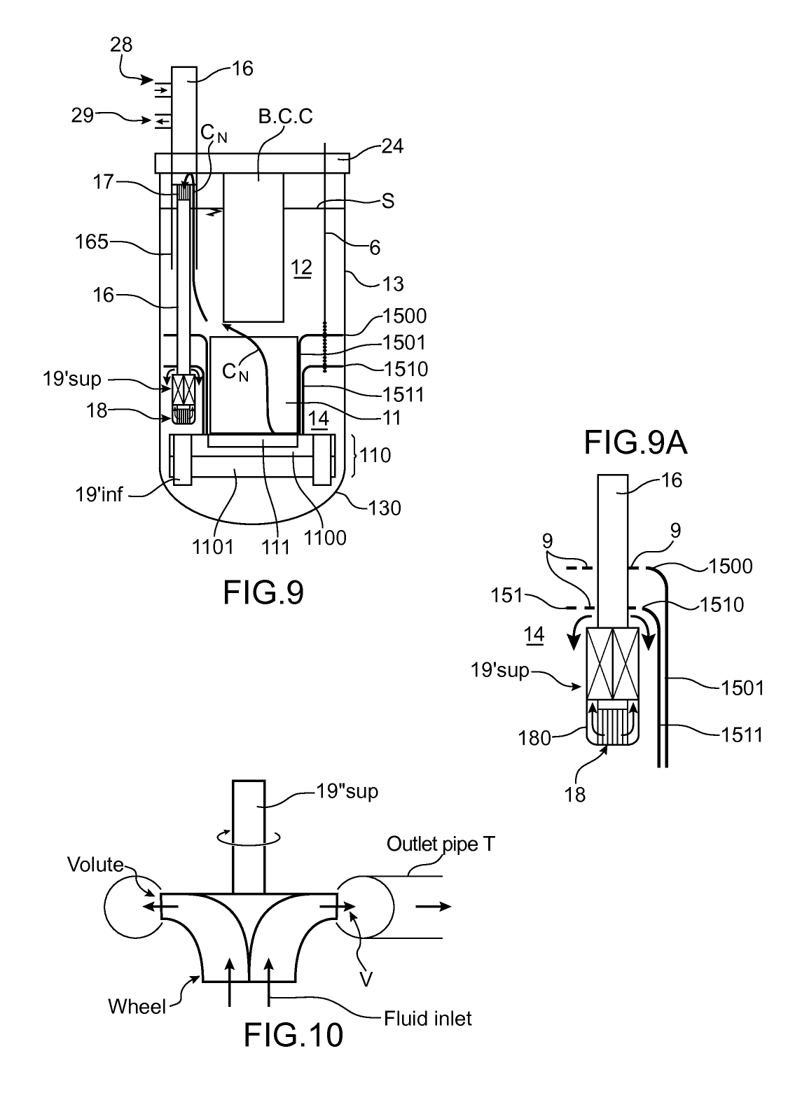

In a particular embodiment as illustrated in FIGS. 9 and 9A, it is possible to place the pumps 19′sup of the intermediate exchangers 16 no longer upstream of the exchangers as is described with reference to FIG. 3, but downstream of the intermediate exchangers 16. This has the advantage of making the electromagnetic pumps operate in an environment of sodium of less high temperature, corresponding to the temperature of the cold collector 14 instead of that of the hot collector 12 for the embodiment of FIG. 3.

In FIGS. 9 and 9A, it may be seen that the sodium passes through the intermediate exchanger 16 thanks to the upper electromagnetic pump 19′sup, which is placed at the outlet 18 of the exchanger 16. The sodium penetrates into the exchanger by means of a supply skirt 165 placed around the exchanger 16. This skirt 165 makes it possible to channel the sodium taken from the hot collector 12 to the inlet window 17 of the intermediate exchanger 16. This skirt 165 is sealed in the upper part, if the inlet window of the sodium is above the free surface S of the hot collector 12. At the outlet 18 of the intermediate exchanger 16, a skirt 180 around the outlet window 18 channels the sodium coming out of the window 180 to the inlet of the electromagnetic pump (or pumps) 19′sup. The outlet of the electromagnetic pumps is in the cold collector 14 under the lower wall 151, 1510, 1511 of the redan. The electromagnetic pump 19′sup being larger than the exchanger 16, the walls of the redan comprise a through hole larger at the level of the opening of the exchanger to introduce the exchanger and its pumps. In order to reduce the hydraulic section of passage between the area of the redan and the hot and cold collectors, two flanges 9 are fixed on the intermediate exchanger 16, each being provided at the same level as one of the horizontal portions 1500, 1510 of the walls 150, 151 constituting the redan. The section of these flanges 9 corresponds approximately to the straight section of the electromagnetic pumps situated downstream of the intermediate exchangers 16, whether those 19′sup placed against the exchangers 16 or the pumps 19′inf supplying the core 11.

According to a particular embodiment of the invention, rotodynamic pumps 19″ sup devoid of volute are used as means of pumping the sodium passing through the intermediate exchangers 16. Rotodynamic pumps are particularly interesting when they are placed at the outlet 18 of the exchanger 16 and when they drive the coolant not into a conduit but into a volume 14. In fact, the fact of expelling the fluid into a volume makes it possible to eliminate the volute usually in this type of pump which serves to collect the pressurised fluid and to channel it towards a pipe. The elimination of this volute reduces the size diameter of the rotodynamic pump and makes it comparable to that of electromagnetic pumps, which makes it possible to maintain the compactness of the SFR nuclear reactor. The operating principle of a standard rotodynamic pump 19″sup is illustrated in FIG. 10: it is a pump in which the gain in pressure of the fluid is obtained by bringing into rotation an impeller R. Those skilled in the art may refer to the manual “Les techniques de I'ingénieur B4304” to understand the more detailed operation of a rotodynamic pump. Thus, as is represented in FIG. 10, the fluid enters into the impeller R axially and comes out with a radial component obtained by the rotation of the impeller. The fluid is then collected by a doughnut shaped volute V surrounding the impeller, then channelled to an outlet pipe T. Thus, the inventors have concluded that a rotodynamic pump devoid of volute 19″sup could be used for the flow of the sodium in the intermediate exchangers 16.

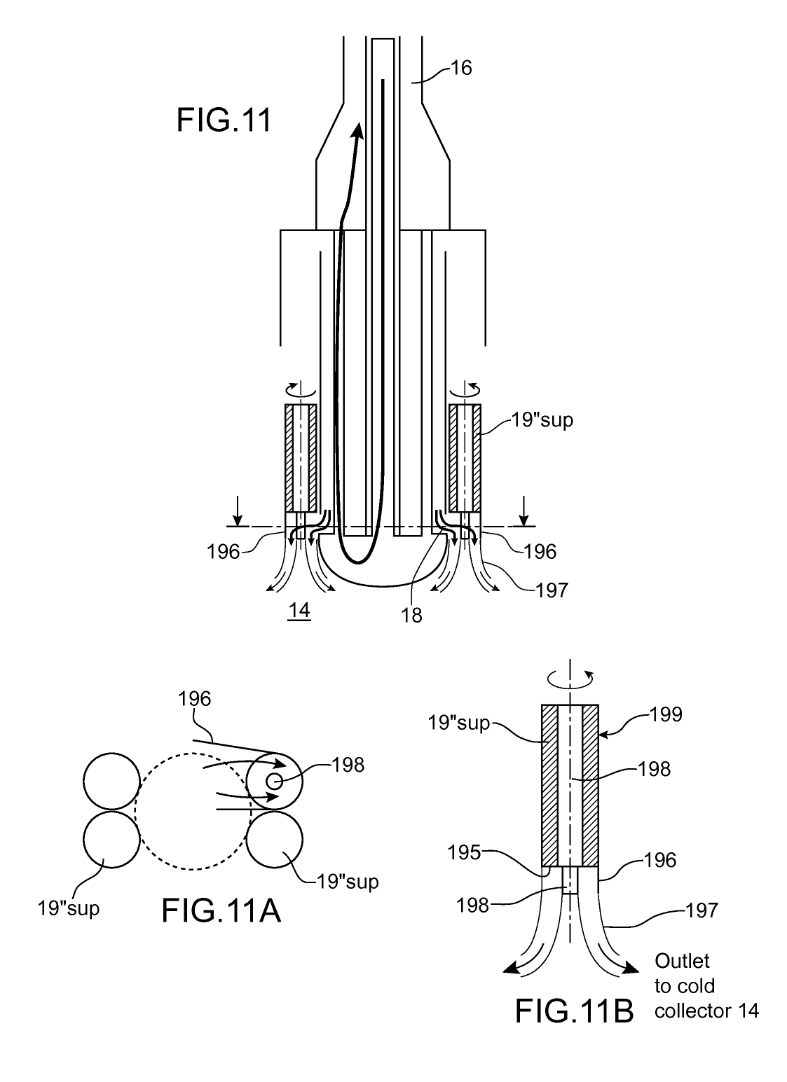

FIGS. 11, 11A and 11B represent an example of embodiment with an intermediate exchanger 16 comprising four rotodynamic pumps 19″sup. At the outlet 18 of the exchanger 16, the sodium is channelled from the outlet windows 18 to the inlet 195 of the pumps. This channelling is achieved by means of deflectors 196, each deflector 196 channelling a portion of the outlet flow of the intermediate exchanger 16 in a manner inversely proportional to the number of pumps 19″sup. Thus, for an intermediate exchanger with four pumps, each deflector 196 is fixed opposite by approximately a quarter of outlet window 18 of the exchanger (FIG. 11A). The fluid thus channelled enters axially into the impeller 197 of the pump, then is raised in pressure thanks to the rotation of the impeller 197 integral with the shaft 198 caused by the actuation of the electric motor 199. The fluid then comes out of the impeller 197 directly into the cold collector 14 of the reactor, without there being any need for a volute. The motor 199 bringing into rotation the impeller 197 of the pump may be constituted of stator coils covered with a leak tight metal sheet in order to be able to be totally immersed in the sodium contained in the reactor.

1-18. (canceled)

19. SFR nuclear reactor of the integrated type, comprising a vessel adapted to be filled with sodium and inside of which are provided a core, pumping means for the flow of the primary sodium, first heat exchangers, known as intermediate exchangers, adapted to evacuate the power produced by the core during normal operation from second heat exchangers adapted to remove the decay heat produced by the core while stopped when the pumping means are also stopped, a separation device defining a hot area and a cold area in the vessel, wherein:
the separation device is constituted of two walls each with a substantially vertical portion provided surrounding the core and a substantially horizontal portion, the substantially horizontal portions being separated from each other by a height and the space defined above the horizontal portion of the upper wall forming the hot area whereas the space defined below the horizontal portion of the lower wall forms the cold area and the substantially horizontal portions are provided with clearances in relation to the vessel,
the intermediate exchangers are provided substantially vertically with clearances in first cuts made in each horizontal portion of the wall of the separation device so as to localise their outlet windows below the horizontal portion of the lower wall,
the pumping means with variable flow are divided into two groups hydraulically in series, one provided below the horizontal portion of the lower wall for the flow of the sodium from the cold area to the hot area through the core, the other provided next to the intermediate exchangers for the flow of the sodium from the hot area to the cold area through the intermediate exchangers,
temperature acquisition means are provided in the space defined between the horizontal portions of the two walls in being spread out along a substantially vertical axis to determine in real time the thermal stratification in said space,
automatic control means connected on the one hand to the temperature acquisition means and on the other hand to the two pumping groups are provided to modify if necessary the flow of at least one pumping group in order to maintain a satisfactory level of stratification during normal operation,
the second exchangers are provided substantially vertically above the cold area,
means to enable the natural convection of the primary sodium from the second exchangers to the cold area when the core and the pumping means are also stopped,
all of the clearances and the height between the horizontal portions of the two walls of the separation device are previously determined so as to, during normal operation, take up differential movements between the walls, exchangers and vessel and to make it possible to establish during normal operation a thermal stratification of the primary sodium in the space defined between the horizontal portions of the two walls and to reduce, in case of an unexpected stop of a single pumping group, the mechanical stress applied to the walls and due to the portion of the primary sodium flow passing between said clearances.

20. SFR nuclear reactor of the integrated type according to claim 19, wherein the group of pumping means provided next to the intermediate exchangers for the flow of the sodium from the hot area to the cold area through the intermediate exchangers is upstream of them.

21. SFR nuclear reactor of the integrated type according to claim 19, wherein the group of pumping means provided next to the intermediate exchangers for the flow of the sodium from the hot area to the cold area through the intermediate exchangers is downstream of them.

22. SFR nuclear reactor of the integrated type according to claim 19, wherein the group of pumping means provided next to the intermediate exchangers for the flow of the sodium from the hot area to the cold area through the intermediate exchangers comprise electromagnetic pumps and/or rotodynamic pumps devoid of volute.

23. SFR nuclear reactor of the integrated type according to claim 22, wherein electromagnetic pumps and/or rotodynamic pumps devoid of volute for the flow of the sodium from the hot area to the cold area are moreover provided in closed circuit with the inlet windows of the intermediate exchangers.

24. SFR nuclear reactor of the integrated type according to claim 23, wherein at least one electromagnetic pump or one rotodynamic pump devoid of volute is fixed in being placed in the direction of its height against the outer casing of an intermediate exchanger separating the inlet and outlet windows and wherein a conduit directly connects the outlet of the pump and one of the inlet windows of the intermediate exchanger.

25. SFR nuclear reactor of the integrated type according to claim 23, wherein at least one electromagnetic pump or one rotodynamic pump devoid of volute is fixed in being placed in the direction of its height against the outer casing of an intermediate exchanger separating the inlet and outlet windows and wherein a conduit directly connects the inlet of the pump and one of the outlet windows of the intermediate exchanger.

26. SFR nuclear reactor of the integrated type according to claim 19, wherein the group of pumping means provided below the horizontal portion of the lower wall for the flow of the sodium from the cold area to the hot area through the core comprises electromagnetic pumps.

27. SFR nuclear reactor of the integrated type according to claim 26, wherein the electromagnetic pumps are moreover provided in the support of the core.

28. SFR nuclear reactor of the integrated type according to claim 27, wherein the electromagnetic pumps provided in the core support are moreover arranged substantially directly in line with the intermediate exchangers.

29. SFR nuclear reactor of the integrated type according to claim 27, wherein when the straight section of the lower electromagnetic pumps is greater than the straight section of an intermediate exchanger, the latter comprises two transversal flanges separated from each other by a distance that corresponds to the height separating the two horizontal portions of the walls, the flanges each being arranged opposite said horizontal portions defining the clearances between the intermediate exchanger and walls.

30. SFR nuclear reactor of the integrated type according to claim 27, wherein the lay out of the electromagnetic pumps in the core support makes it possible to direct the primary sodium at the outlet from said pumps to the base of the fuel assemblies constituting the core.

31. SFR nuclear reactor of the integrated type according to claim 27, wherein the electromagnetic pumps are connected in sets to an intermediate exchanger by means of a flexible link, the flexibility of this link making it possible both to accommodate differential expansions between the intermediate exchanger and the set of electromagnetic pumps and to carry out a simultaneous assembly or a dismantling of the intermediate exchanger and the set of electromagnetic pumps by pushing or pulling force from the exterior top to the covering slab of the vessel.

32. SFR nuclear reactor of the integrated type according to claim 31, wherein the flexible links are moreover dimensioned to serve as housings for electrical power supply cables of the electromagnetic pumps provided in the core support.

33. SFR nuclear reactor of the integrated type according to claim 19, wherein the temperature acquisition means in the space defined by the two walls are constituted of thermocouples fixed on one or more booms at different levels, the boom(s) being arranged substantially vertically and extractible from the exterior top to the covering slab of the vessel.

34. SFR nuclear reactor of the integrated type according to claim 19, wherein the second exchangers are provided with clearances at least in second cuts made in the horizontal portion of the upper wall of the separation device so as to localise their outlet windows below it.

35. SFR nuclear reactor of the integrated type according to claim 34, wherein the outlet windows of the second exchangers are arranged immediately below the horizontal portion of the upper wall in the hottest height of the stratification established between the two horizontal portions.

36. SFR nuclear reactor of the integrated type according to claim 19, wherein third cuts made in the horizontal portion of the lower wall are arranged directly in line with second cuts in which are provided individually the second exchangers in order to further improve the natural convection of the primary sodium when the core and the pumping means are stopped.
